(19) United States
(12) Patent Application Publication
(10) Pub. No.: US 2026/0370723 A1
(43) Pub. Date: Nov. 19, 2026

(54) SDK-Based Event Reporting With Fault Tolerance

(71) Applicant: Google LLC, Mountain View, CA (US)

(72) Inventors: Spencer Johnson, Morgan Hill, CA (US); Calvin Cheng, New York City, NY (US); David Lerner Lombrozo, San Jose, CA (US); Kelly Jin, Newark, CA (US); Daniel Stephen Padgett, San Francisco, CA (US)

(21) Appl. No.: 19/207,846

(22) Filed: May 14, 2025

(51) Int. Cl. H04L 67/145; H04L 67/02

(52) U.S. Cl. CPC H04L 67/145; H04L 67/02

(57) ABSTRACT

Aspects of the disclosure are directed to event reporting in environments with unreliable network connectivity. A software development kit (SDK) includes retry logic and buffering logic for reporting a digital content event. If the SDK detects that a ping to a backend server was unsuccessful, the retry logic allows the SDK to attempt to ping the backend server again for a configurable number of attempts distributed over a configurable duration and frequency. If the retry attempts are unsuccessful, the buffering logic allows the SDK to store relevant information for reporting the digital content event in memory, such as a buffer, to be dispatched when the SDK detects that a network connection has been reestablished.

### BACKGROUND OF THE INVENTION

Digital content networks often utilize software development kits (SDKs) to facilitate the delivery and tracking of digital content within mobile applications. These SDKs handle the complexities of requesting, displaying, and monitoring user interactions with content. Current digital content network SDKs typically rely on network connectivity to report specific events related to digital content interaction. For instance, when a user views or clicks on an advertisement, the SDK attempts to transmit this information to a backend server. This transmission often takes the form of a ping sent via hypertext transfer protocol (HTTP). A significant limitation of existing digital content network SDKs lies in their vulnerability to network disruptions. In scenarios where a mobile device loses or experiences intermittent network connectivity, the SDK may be unable to successfully send event-reporting pings. This failure to report events can lead to inaccurate data collection and reporting.

### BRIEF SUMMARY OF THE INVENTION

Aspects of the disclosure are directed to event reporting in environments with unreliable network connectivity. A software development kit (SDK) includes retry logic and buffering logic for reporting a digital content event. If the SDK detects that a ping to a backend server was unsuccessful, the retry logic allows the SDK to attempt to ping the backend server again for a configurable number of attempts distributed over a configurable duration and frequency. If the retry attempts are unsuccessful, the buffering logic allows the SDK to store relevant information for reporting the digital content event in memory, such as a buffer, to be dispatched when the SDK detects that a network connection has been reestablished.

An aspect of the disclosure provides for a method for reporting a digital content event associated with a software application, the method including: receiving, by one or more processors, an input associated with the digital content event; attempting, by the one or more processors, to report the digital content event; determining, by the one or more processors, that the attempt to report the digital content event failed due to a network connection issue; retrying, by the one or more processors, the attempting to report the digital content event for a predetermined number of attempts with a predetermined duration and frequency; determining, by the one or more processors, that the retried attempts to report the digital content event failed; and storing, by the one or more processors, the digital content event in memory. Another aspect of the disclosure provides for a system including one or more processors configured to perform the method for reporting a digital content event associated with a software application. Yet another aspect of the disclosure provides for a non-transitory computer-readable medium storing instructions that, when executed by one or more processors, cause the one or more processors to perform the method for reporting a digital content event associated with a software application.

In some examples, the method further includes: determining, by the one or more processors, that the network connection has been reestablished; and attempting, by the one or more processors, to report the digital content event stored in memory.

In some examples, the input associated with the digital content event comprises at least one of an impression, click, engaged view, swipe, or playback ping associated with an advertisement within the software application. In some examples, the software application is a mobile application. In some examples, the predetermined number of attempts is configurable. In some examples, the predetermined duration is configurable. In some examples, the predetermined frequency is configurable.

In some examples, attempting to report the digital content event further includes attempting to ping a backend server for the software application. In some examples, the ping is via hypertext transfer protocol (HTTP).

In some examples, the memory is at least one of a buffer or cache. In some examples, storing the digital content event further comprises storing an HTTP request in the memory.

### BRIEF DESCRIPTION OF THE DRAWINGS

FIG. 1 depicts a flow diagram of an example process for managing unsuccessful reporting attempts where a retry is successful according to aspects of the disclosure.

FIG. 2 depicts a flow diagram of an example process for managing unsuccessful reporting attempts where the retries are unsuccessful according to aspects of the disclosure.

FIG. 3 depicts a flow diagram of an example process for managing buffered digital content reporting according to aspects of the disclosure.

FIGS. 4-6 depict diagrams of example data flow for reporting digital content events according to aspects of the disclosure.

FIG. 7 depicts a block diagram of an example environment for reporting digital content events according to aspects of the disclosure.

### DETAILED DESCRIPTION

The technology is directed to event reporting in environments with unreliable network connectivity. A digital content SDK includes logic for reporting a digital content event including: receiving an input associated with the digital content event attempting to report the digital content event; determining that the attempt to report the digital content event failed due to a network connection issue; retrying the attempt to report the digital content event for a predetermined number of attempts over a predetermined duration and frequency; determining that the retried attempts to report the digital content event failed; and storing the digital content event in memory, on disk, or other storage.

When the digital content SDK attempts to ping a backend server with a specific event, the digital content SDK may detect that this ping failed due to a lack or loss of network connectivity. In response, the digital content SDK attempts again to ping the backend server for a configurable number of attempts distributed over a configurable duration and frequency. For example, the digital content SDK can attempt to ping the backend server linearly, e.g., every x seconds, where x is any number greater than 0. As another example, the digital content SDK can attempt to ping the backend server exponentially, e.g., (2\hat{ }0)x seconds, (2\hat{ }1)x seconds, (2\hat{ }2)x seconds, where x is any number greater than 0.

If the retry attempts are unsuccessful, or retry logic is not enabled or implemented, the digital content SDK may store the relevant HTTP requests in memory, e.g., a buffer, and dispatch them when the digital content SDK detects that a network connection has been reestablished. The HTTP requests may include hypertext transfer protocol secure (HTTPS) requests. The digital content SDK may store, as HTTP requests, impressions, events, and clicks, as examples. When multiple retries are attempted, the digital SDK may store HTTP requests associated with a single impression, event, and ping to reduce buffer size.

In some examples, the digital content SDK may store only HTTP requests corresponding to impressions or impressions and clicks to reduce storage costs in the memory. The digital content SDK can determine whether the digital content can have offline functionality, e.g., storing in the memory, and the extent of the digital content that can be stored in the memory, e.g., whether there are dependencies. For example, the digital content SDK may have notification flow enabled. In this example, the digital content SDK may only store a click if a notification is clicked prior. The digital content SDK can remove HTTP requests from memory once particular events occur to save storage costs. For example, the digital content SDK can remove the HTTP request from memory once a click occurs or once a device reestablishes a network connection.

The retry logic and buffering logic allow for reporting the specific events, regardless of network connectivity, resulting in more accurate event reporting. The buffering logic also allows for saving storage costs by determining what offline functionality should be available based on the digital content. Additionally, by reducing the number of retries a device makes to report an event, device battery usage and network usage may be reduced.

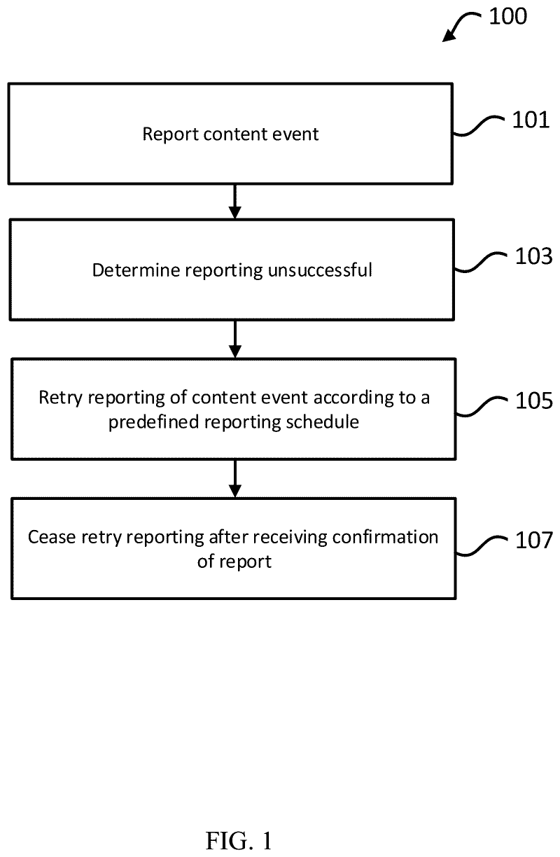

FIG. 1 depicts a flow diagram of an example process 100 depicting steps for managing unsuccessful reporting attempts where a retry is successful. The example process 100 can be performed on a system of one or more processors in one or more locations, such as the digital content SDK. The digital content SDK may be implemented in a user device. The user device can be any computing device, such as a desktop computer, laptop computer, tablet, and/or smartphone.

As shown in block 101, the digital content SDK reports a content event. The content event may be a click, impression, or other event associated with digital content viewed in a software application, e.g., a mobile application. The digital content SDK can attempt to ping a backend server with the content event.

As shown in block 103, the digital content SDK determines the reporting is unsuccessful. The digital content SDK can detect that the ping to the backend server failed due to a lack or a loss of network connectivity.

As shown in block 105, the digital content SDK retries reporting of the content event according to a predefined reporting schedule. The predefined reporting schedule can include a configurable number of attempts distributed over a configurable duration and/or frequency. For example, the digital content SDK may perform retry reporting of the content event linearly or exponentially. The digital content SDK can attempt to ping the backend server with the content event for the configurable number of attempts over the configurable duration and/or frequency. The retry reporting allows for more accurate event reporting, as content events may still be reported even if the first attempt is unsuccessful due to network connectivity issues.

As shown in block 107, the digital content SDK ceases retry reporting after receiving confirmation that the report is successful. The digital content SDK can receive an acknowledgement that one of the attempts to ping the backend server with the content event was successful, thus indicating further retries are not needed. Stopping the retry reporting once a report was successful allows for reducing the number of retries a device makes to report an event, resulting in reduced device battery usage and network bandwidth.

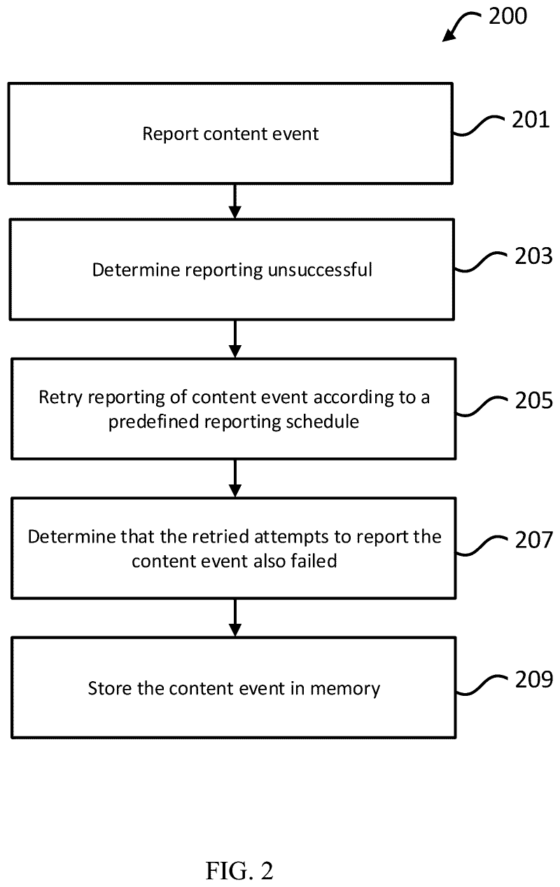

FIG. 2 depicts a flow diagram of an example process 200 for managing unsuccessful reporting attempts where the retries are unsuccessful. The example process 200 can be performed on a system of one or more processors in one or more locations, such as the digital content SDK.

As shown in block 201, the digital content SDK reports a content event. As shown in block 203, the digital content SDK determines the reporting is unsuccessful. As shown in block 205, the digital content SDK retries reporting of the content event according to a predefined reporting schedule. Blocks 201, 203, and 205 respectively correspond to blocks 101, 103, and 105 as depicted in FIG. 1.

As shown in block 207, the digital content SDK determines that the retried attempts to report the content event are also unsuccessful. The digital content SDK can detect that the retried pings to the backend server failed due to a lack or a loss of network connectivity.

As shown in block 209, the digital content SDK can store the content event in memory. The memory may be a buffer and/or cache. The memory may be part of the user device or separate storage from the user device, e.g., cloud storage. The digital content SDK may store any content event or may selectively store content events. Whether to store all content events or some content events may be configurable, and if some content events, which content events to store may also be configurable. Storing the content events in memory allows for more accurate event reporting, as content events may still be reported at a later period in time when network connectivity is regained. Further, selectively storing content events in memory allows for saving storage costs since less content events are stored in memory.

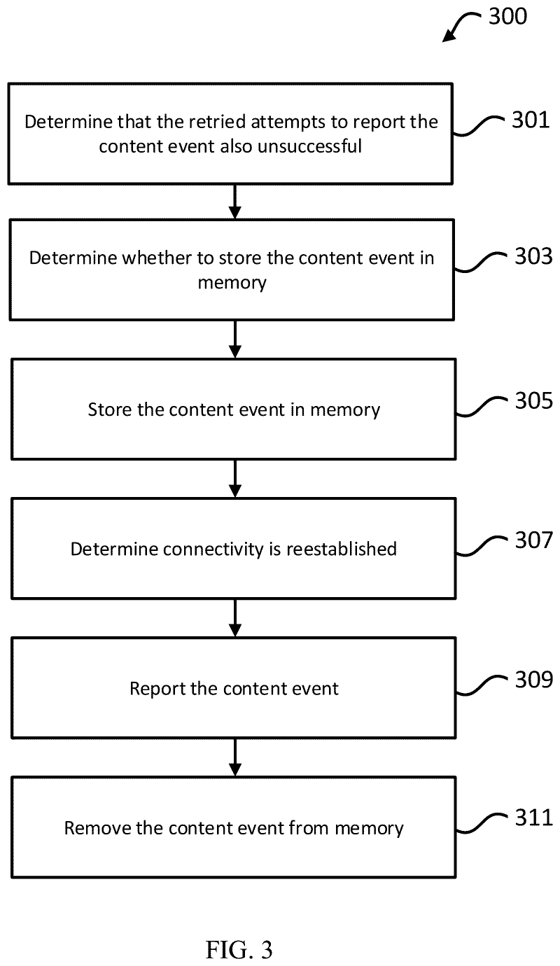

FIG. 3 depicts a flow diagram of an example process 300 for managing buffered digital content reporting. The example process 300 can be performed on a system of one or more processors in one or more locations, such as the digital content SDK.

As shown in block 301, the digital content SDK determines that the retried attempts to report the content event are also unsuccessful. Block 301 corresponds to block 207 as depicted in FIG. 2.

As shown in block 303, the digital content SDK determines whether to store the content event in memory. Whether to store content events and/or which content events to store may be configurable. For example, the digital content SDK may be configured to store all content events. As another example, the digital content SDK may be configured to store impressions only. As yet another example, the digital content SDK may be configured to store impressions and clicks. As yet another example, the digital content SDK may be configured not to store any content events, e.g., have offline functionality disabled. Which content events to store may also have configurable dependencies. For example, the digital content SDK may be configured to store a click if a notification is clicked prior.

As shown in block 305, the digital content SDK stores the content event in memory. Block 305 corresponds to block 209 as depicted in FIG. 2.

As shown in block 307, the digital content SDK determines connectivity is reestablished. The digital content SDK can periodically send a test ping to the backend server. How often the digital content SDK sends the test ping can be configurable to reduce battery usage and network bandwidth. The digital content SDK can receive an acknowledgement from the backend server that the test ping was successful, indicating that network connectivity has been reestablished. If the digital content SDK does not receive an acknowledgement, then there may still be a lack of network connectivity. Alternatively, or additionally, the digital content SDK can monitor a connection status of the user device using a callback API. When connectivity is reestablished, the callback API can send a notification to the digital content SDK indicating that the connectivity has been reestablished.

As shown in block 309, the digital content SDK reports the content event. The digital content SDK can ping the backend server with the content event.

As shown in block 311, the digital content SDK removes the content event from the memory. The digital content SDK can remove the content event in response to particular occurrences. The particular occurrences may be configurable. For example, the digital content SDK can remove the content event once a click occurs. As another example, the digital content SDK can remove the content event once connectivity is reestablished.

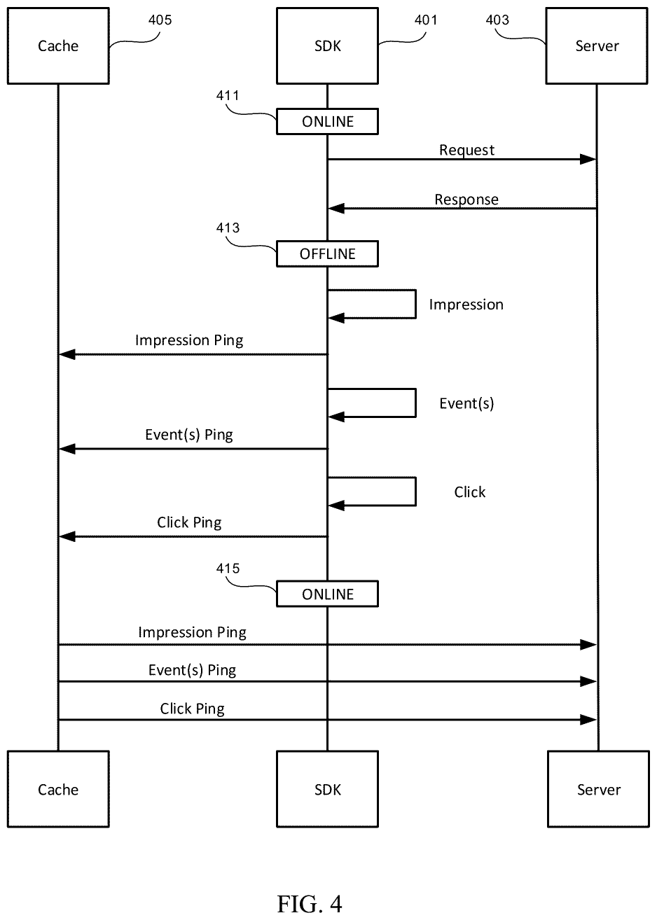

FIGS. 4-6 depict diagrams of example data flow for reporting digital content events. The data flow is between a digital content SDK 401, a backend server 403, and a cache 405. The cache 405 may also be a buffer or any other memory.

When the digital content SDK 401 has online functionality 411, the digital content SDK 401 establishes a connection with the backend server 403. The digital content SDK 401 can send requests to the backend server 403, and the backend server 403 can send responses to the digital content SDK 401. More specifically, the digital content SDK 401 can ping the backend server 403 with a content event and, upon receipt, the backend server 403 can send an acknowledgement that the ping was successful.

When the digital content SDK 401 has offline functionality 413, the digital content SDK 401 does not have a connection with the backend server 403. The digital content SDK 401 will fail to send requests to the backend server 403, and thus the backend server 403 will not send responses to the digital content SDK 401. Therefore, the digital content SDK can store the requests in the cache 405. More specifically, the digital content SDK 401 can store content events in the cache. Content events may include impressions, clicks, or other events, as examples. Events may refer to any interaction between a user and a device based on digital content presented to the user on the device. Example events include impressions, clicks, engaged views, swipes, and/or playback pings, e.g., playback quartile pings.

When the digital content SDK 401 reestablishes online functionality 415, the digital content SDK 401 has a connection with the backend server 403. The digital content SDK 401 can remove the requests from the cache 405 that were stored during offline functionality 413 and can send the requests to the backend server 403. More specifically, the digital content SDK 401 can remove the content events from the cache 405 and send the content events to the backend server 403.

As described with respect to FIG. 3, the digital content SDK 401 may be configurable on whether to store the content events in the cache 405 and/or select which content events to store in the cache 405. The digital content SDK 401 may also be configurable on when to remove the content events from the cache 405 once the digital content SDK 401 reestablishes online functionality 415.

For example, as depicted in FIG. 4, the digital content SDK 401 stores impressions, clicks, and other events in the cache 405 during offline functionality 413 and sends the impressions, clicks, and other events in the cache 405 to the backend server 403 when the digital content SDK 401 reestablishes online functionality 415.

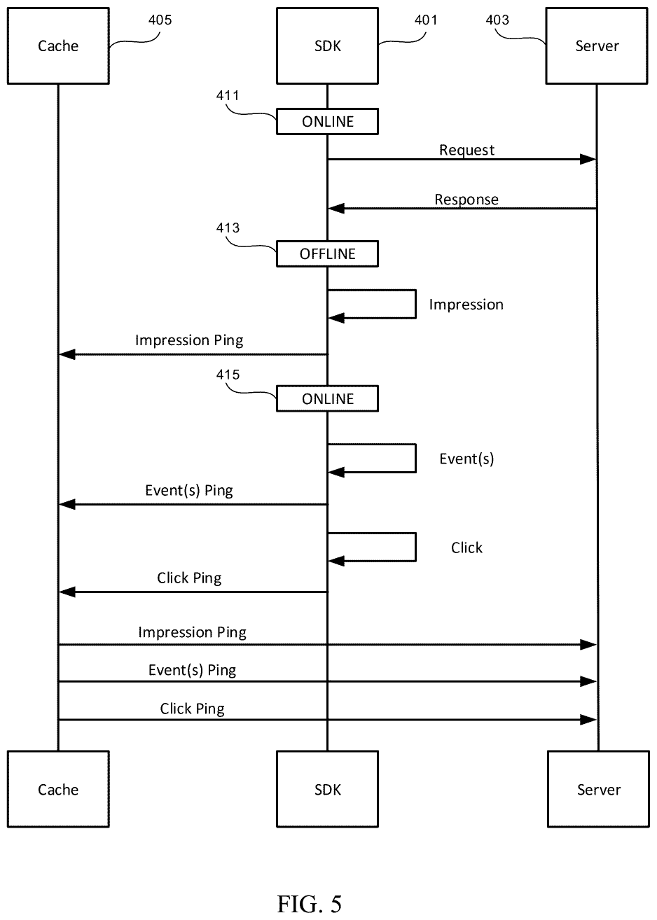

As another example, as depicted in FIG. 5, the digital content SDK 401 stores impressions in the cache 405 during offline functionality 413. When the digital content SDK 401 reestablishes online functionality 415, the digital content SDK 401 stores clicks and other events in the cache 405 and then sends the impressions, clicks, and other events in the cache 05 to the backend server 403. The digital content SDK 401 can send the impressions, clicks, and other events to the backend server 403 immediately or can buffer to reconcile ordering of the impressions, clicks, and other events using timestamps prior to sending to the backend server 403. More specifically, the digital content SDK 401 does not send the impressions to the backend server 403 until also receiving a related click and event, regardless of reestablishing online functionality 415.

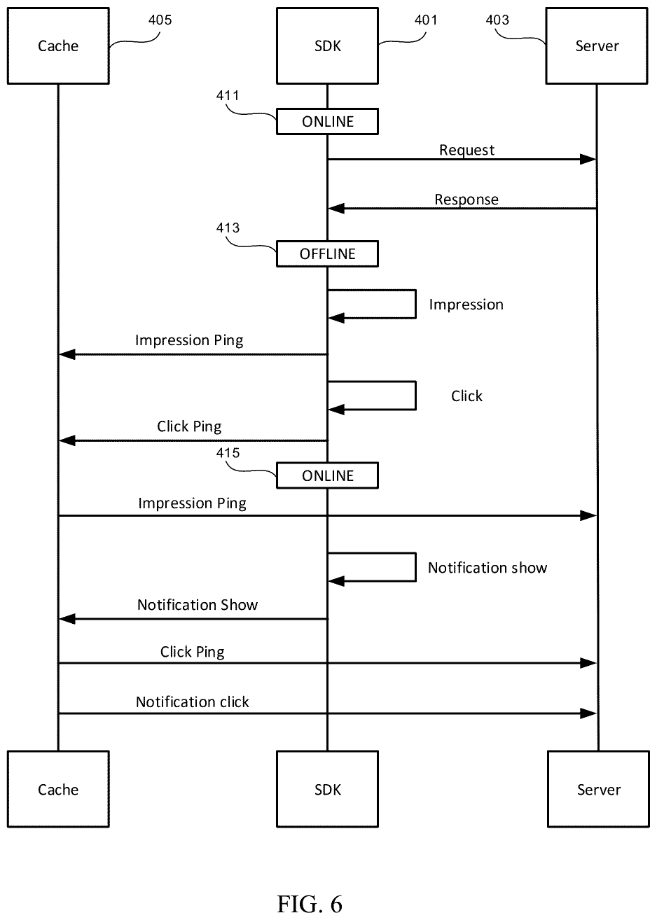

As yet another example, as depicted in FIG. 6, the digital content SDK 401 stores impressions and clicks in the cache 405 during offline functionality 413. When the digital content SDK 401 reestablishes online functionality 415, the digital content SDK 401 sends the impressions to the backend server 403. The digital content SDK 401 stores notifications in the cache 405 and then sends the clicks and notifications to the backend server 403. The notification can inform the user that an activity they previously attempted could not be completed during offline functionality 413, but can now be revisited and completed as online functionality 415 is reestablished. Therefore, whether to send the click to the backend server 403 may depend on whether the notification is clicked on or otherwise interacted with as well. More specifically, the digital content SDK 401 does not send the clicks to the backend server 403 until also receiving a related notification, regardless of reestablishing online functionality 415.

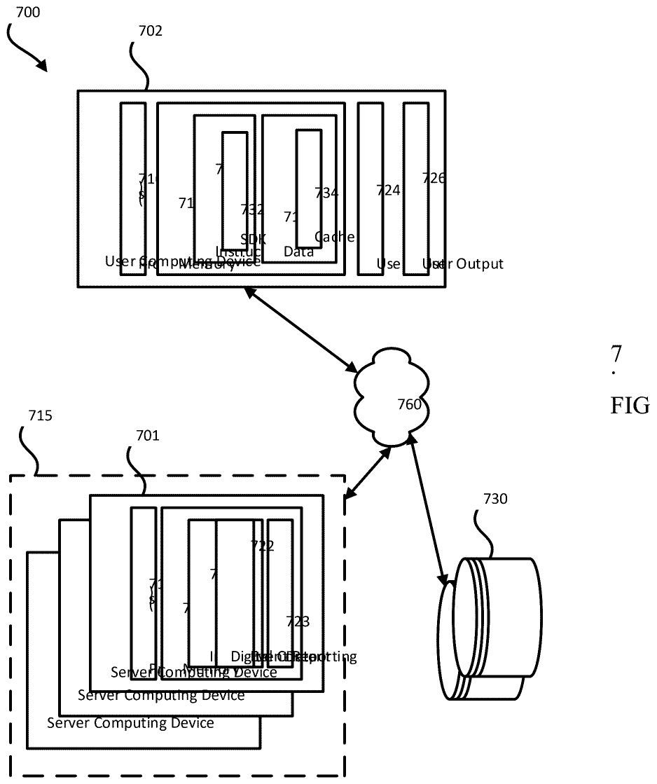

FIG. 7 depicts a block diagram of an example environment 700 for reporting digital content events. Reporting digital content events can be implemented by at least one user computing device 702 communicating with one or more server computing devices 715. For example, and as illustrated in FIG. 7, client computing device 702 and server computing devices 715 can be communicatively coupled to one or more storage devices 730 over a network 760. The storage devices 730 can be a combination of volatile and non-volatile memory and can be at the same or different physical locations than the user computing devices or server computing devices 715, collectively referred to as “computing devices.” For example, the storage devices 730 can include any type of non-transitory computer readable medium capable of storing information, such as a hard-drive, solid state drive, tape drive, optical storage, memory card, ROM, RAM, DVD, CD-ROM, write-capable, and read-only memories.

Server computing devices 715 can include processors and memory. For example, server computing device 701 can include one or more processors 713 and memory 714. The memory 714 can store information accessible by the processors 713, including instructions 721 that can be executed by the processors 713. The memory 714 can also include data 723 that can be retrieved, manipulated, or stored by the processors 713. The memory 714 can be a type of transitory or non-transitory computer readable medium capable of storing information accessible by the processors 713, such as volatile and non-volatile memory. The processors 713 can include one or more central processing units (CPUs), graphic processing units (GPUs), field-programmable gate arrays (FPGAs), and/or application-specific integrated circuits (ASICs), such as tensor processing units (TPUs).

The instructions 721 can include one or more instructions that, when executed by the processors 713, cause the one or more processors 713 to perform actions defined by the instructions 721. The instructions 721 can be stored in object code format for direct processing by the processors 713, or in other formats including interpretable scripts or collections of independent source code modules that are interpreted on demand or compiled in advance. The instructions 721 can include instructions for handling digital content event reporting 722, such as digital content events reported from a user computing device, such as user computing device 702. In some instances, the server computing device 701 may include instructions for providing digital content in response to digital content requests received from user computing devices, such as user computing device 702. The digital content event reporting 722 can be executed using the processors 713, and/or using other processors remotely located from the server computing device 701.

The data 723 can be retrieved, stored, or modified by the processors 713 in accordance with the instructions 721. The data 723 can be stored in computer registers, in a relational or non-relational database as a table having a plurality of different fields and records, or as JSON, YAML, proto, or XML documents. The data 723 can also be formatted in a computer-readable format such as, but not limited to, binary values, ASCII, or Unicode. Moreover, the data 723 can include information sufficient to identify relevant information, such as numbers, descriptive text, proprietary codes, pointers, references to data stored in other memories, including other network locations, or information that is used by a function to calculate relevant data. Each server computing device 715 can include some or all of the components, instructions, data, etc., of server computing device 701.

The client computing device 702 can also be configured similarly to the server computing device 701, with one or more processors 716, memory 717, instructions 718, and data 719. The client computing device 702 can also include a user input 724 and a user output 726. The user input 724 can include any appropriate mechanism or technique for receiving input from a user, such as keyboard, mouse, mechanical actuators, soft actuators, touchscreens, microphones, and sensors.

The instructions 718 of the client computing device 702 may include an SDK 732, through which digital content event reporting may be implemented, including the buffering and retry logic, as described herein. Additionally, the data 719 of the client computing device 702 may include cache 734, in which HTTP requests may be stored, as described herein.

The server computing devices 715 can be configured to transmit data to the client computing device 702, and the client computing device 702 can be configured to display at least a portion of the received data on a display implemented as part of the user output 726. The user output 726 can also be used for displaying an interface between the client computing device 702 and any or all of the server computing devices 715. The user output 726 can alternatively or additionally include one or more speakers, transducers or other audio outputs, a haptic interface or other tactile feedback that provides non-visual and non-audible information to the platform user of the client computing device 702.

Although FIG. 7 illustrates the processors 713, 716 and the memories 714, 717 as being within the respective computing devices 701, 702, components described herein can include multiple processors and memories that can operate in different physical locations and not within the same computing device. For example, some of the instructions 721, 718 and the data 723, 719 can be stored on a removable SD card and others within a read-only computer chip. Some or all of the instructions 721, 718 and data 723, 719 can be stored in a location physically remote from, yet still accessible by, the processors 713, 716. Similarly, the processors 713, 716 can include a collection of processors that can perform concurrent and/or sequential operations. The computing devices 701, 702 can each include one or more internal clocks providing timing information, which can be used for time measurement for operations and programs run by the computing devices 701, 702.

The server computing devices 715 can be connected over the network 760 to a data center housing any number of hardware accelerators. The data center can be one of multiple data centers or other facilities in which various types of computing devices, such as hardware accelerators, are located. Computing resources housed in the data center can be specified for deploying models, such as for determining digital content to provide to a user computing device.

The server computing device 701 can be configured to receive requests to process data from the client computing device 702 on computing resources in the data center. For example, server computing devices 715 can be part of a computing platform configured to provide a variety of services to users, through various user interfaces and/or application programming interfaces (APIs) exposing the platform services. The client computing device 702 can transmit a request for digital content, such as through SDK 732. The server computing device 701 may, in response to the request, provide digital content to the user computing device 702.

Aspects of this disclosure can be implemented in digital electronic circuitry, in tangibly embodied computer software or firmware, and/or in computer hardware, such as the structure disclosed herein, their structural equivalents, or combinations thereof. Aspects of this disclosure can further be implemented as one or more computer programs, such as one or more modules of computer program instructions encoded on a tangible non-transitory computer storage medium for execution by, or to control the operation of, one or more data processing apparatus. The computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, which is generated to encode information for transmission to suitable receiver apparatus for execution by a data processing apparatus.

The term “configured” is used herein in connection with systems and computer program components. For a system of one or more computers to be configured to perform particular operations or actions means that the system has installed thereon software, firmware, hardware, or a combination thereof that cause the system to perform the operations or actions. For one or more computer programs to be configured to perform particular operations or actions means that the one or more programs include instructions that, when executed by one or more data processing apparatus, cause the apparatus to perform the operations or actions.

The term “data processing apparatus” or “data processing system” refers to data processing hardware and encompasses various apparatus, devices, and machines for processing data, including programmable processors, computers, or combinations thereof. The data processing apparatus can include special purpose logic circuitry, such as a field programmable gate array (FPGA) or an application specific integrated circuit (ASIC). The data processing apparatus can include code that creates an execution environment for computer programs, such as code that constitutes processor firmware, a protocol stack, a database management system, an operating system, or combinations thereof.

The term “computer program” refers to a program, software, a software application, an app, a module, a software module, a script, or code. The computer program can be written in any form of programming language, including compiled, interpreted, declarative, or procedural languages, or combinations thereof. The computer program can be deployed in any form, including as a standalone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “database” refers to any collection of data. The data can be unstructured or structured in any manner. The data can be stored on one or more storage devices in one or more locations. For example, an index database can include multiple collections of data, each of which may be organized and accessed differently.

The term “engine” refers to a software-based system, subsystem, or process that is programmed to perform one or more specific functions. The engine can be implemented as one or more software modules or components or can be installed on one or more computers in one or more locations. A particular engine can have one or more computers dedicated thereto, or multiple engines can be installed and running on the same computer or computers.

The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers.

A computer or special purpose logic circuitry executing the one or more computer programs can include a central processing unit, including general or special purpose microprocessors, for performing or executing instructions and one or more memory devices for storing the instructions and data. The central processing unit can receive instructions and data from the one or more memory devices, such as read only memory, random access memory, or combinations thereof, and can perform or execute the instructions. The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, a personal digital assistant (PDA), a mobile audio or video player, a game console, a Global Positioning System (GPS), or a portable storage device, e.g., a universal serial bus (USB) flash drive, as examples.

Computer readable media suitable for storing the one or more computer programs can include any form of volatile or non-volatile memory, media, or memory devices. Examples include semiconductor memory devices, e.g., EPROM, EEPROM, or flash memory devices, magnetic disks, e.g., internal hard disks or removable disks, magneto optical disks, CD-ROM disks, DVD-ROM disks, or combinations thereof.

Aspects of the disclosure can be implemented in a computing system that includes a back end component, e.g., as a data server, a middleware component, e.g., an application server, or a front end component, e.g., a client computer having a graphical user interface, a web browser, or an app, or any combination thereof. The components of the system can be interconnected by any form or medium of digital data communication, such as a communication network. Examples of communication networks include a local area network (LAN) and a wide area network (WAN), e.g., the Internet.

The computing system can include clients and servers. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for reporting a digital content event associated with a software application, the method comprising:
receiving, by one or more processors, an input associated with the digital content event;
attempting, by the one or more processors, to report the digital content event;
determining, by the one or more processors, that the attempt to report the digital content event failed due to a network connection issue;
retrying, by the one or more processors, the attempting to report the digital content event for a predetermined number of attempts with a predetermined duration and frequency;
determining, by the one or more processors, that the retried attempts to report the digital content event failed; and
storing, by the one or more processors, the digital content event in memory.

2. The method of claim 1, further comprising:
determining, by the one or more processors, that the network connection has been reestablished; and
attempting, by the one or more processors, to report the digital content event stored in memory.

3. The method of claim 1, wherein the input associated with the digital content event comprises at least one of an impression, click, engaged view, swipe, or playback ping associated with an advertisement within the software application.

4. The method of claim 1, wherein the software application is a mobile application.

5. The method of claim 1, wherein the predetermined number of attempts is configurable.

6. The method of claim 1, wherein the predetermined duration is configurable.

7. The method of claim 1, wherein the predetermined frequency is configurable.

8. The method of claim 1, wherein attempting to report the digital content event further comprises attempting to ping a backend server for the software application.

9. The method of claim 8, wherein the ping is via hypertext transfer protocol (HTTP).

10. The method of claim 1, wherein the memory is at least one of a buffer or cache.

11. The method of claim 1, wherein storing the digital content event further comprises storing an HTTP request in the memory.

12. A system for reporting a digital content event associated with a software application, the system comprising one or more processors configured to perform the method of claim 1.

13. A non-transitory computer-readable medium storing instructions that, when executed by one or more processors, cause the one or more processors to perform the method of claim 1.
